(19) United States
(12) Patent Application Publication
(10) Pub. No.: US 2017/0345076 A1
(43) Pub. Date: Nov. 30, 2017

(54) IMAGE-TO-MARKETPLACE BROKERING SYSTEM

(71) Applicant: PAYPAL, INC., San Jose, CA (US)

(72) Inventor: Rahul Nair, San Jose, CA (US)

(21) Appl. No.: 15/167,117

(22) Filed: May 27, 2016

(51) Int. Cl. G06Q 30/06; G06Q 20/12; G06K 9/62; G06Q 30/02; G06K 9/46

(52) U.S. Cl. CPC G06Q 30/0623; G06Q 30/0635; G06Q 30/0282; G06K 9/4671; G06K 9/6267; G06Q 20/12

(57) ABSTRACT

Systems and methods for providing an image-to-marketplace brokering system include a system provider device that receives, through communication over a network with a user device, an expression of interest of an image of a first item, which the system provider device may thereby use to provide an association between the image and a merchandise listing of a second item. The system provider device may then extract information related to the merchandise listing of the second item, and thereby generate a marketplace summary including the information related to the merchandise listing of the second item. Thereafter, the generated marketplace summary may be displayed by way of a user device. Thus, the embodiments described herein provide users with the ability to quickly access information about an item and/or purchase the item that they like without having to personally identify the item or perform their own search for the item.

### BACKGROUND

The present disclosure generally relates to a brokering system, and more particularly to a system which brokers between an image and a marketplace platform.

More and more consumers are purchasing items and services over electronic networks such as, for example, the Internet. Consumers routinely purchase products and services from merchants and individuals alike. The transactions may take place directly between a conventional or online merchant or retailer and the consumer, and payment is typically made by entering credit card or other financial information. Transactions may also take place with the aid of an online or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online and mobile purchases are growing very quickly.

Oftentimes, purchasing decisions are made or influenced by images that a consumer sees while browsing social media, while performing a web-based search, while reading a news article, while reading their e-mail, or while doing any of a variety of other tasks online. Moreover, actual purchases are typically made by way of an online marketplace platform, such as eBay Inc., of San Jose, Calif., Amazon.com Inc. of Seattle, Wash., Alibaba Group Holding Limited, which operates Alibaba.com, of Hangzhou, Zhejiang, China, among others. Currently, when a consumer sees an image (e.g., online) of something they would like to purchase, the consumer must first identify the item in the image and then go to the online marketplace platform and search for the item from the image. Then, assuming the consumer has correctly identified the item in the image, and assuming that their chosen online marketplace platform sells the item they are looking for, the consumer may ultimately be able to purchase the item from the image. Such a process can be quite inefficient, time-consuming, and frustrating.

Thus, there is a need for an image-to-marketplace brokering system which brokers between an image and a marketplace platform.

### BRIEF DESCRIPTION OF THE FIGURES

FIG. 1 is a schematic view illustrating an embodiment of an image-to-marketplace brokering system;

FIG. 2 is a flow chart illustrating an embodiment of a method for providing an image-to-marketplace brokering system;

FIGS. 3A and 3B illustrate an embodiment of a user device including an example of expressing interest in an image;

FIG. 4 illustrates an embodiment of a user device including a screen shot displaying a first marketplace summary;

FIG. 5 illustrates an embodiment of a user device including a screen shot displaying a second marketplace summary;

FIG. 6 illustrates an embodiment of a user device including a screen shot displaying a checkout interface;

FIG. 7 is an illustrative view of an image file including image data and image metadata, in accordance with some embodiments;

FIG. 8 illustrates an embodiment of a user device including a screen shot displaying a third marketplace summary;

FIGS. 9 and 10 illustrate an embodiment of a user device including examples of alternative options by which a user may express interest in an image;

FIG. 11 is a schematic view illustrating an embodiment of a networked system;

FIG. 12 is a perspective view illustrating an embodiment of a user device;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing an image-to-marketplace brokering system which brokers between an image and an online marketplace platform, such as eBay Inc., of San Jose, Calif., Amazon.com Inc. of Seattle, Wash., Alibaba Group Holding Limited, which operates Alibaba.com, of Hangzhou, Zhejiang, China, or others. Additionally, embodiments described herein may be equally applicable to any type of user (e.g., individual, customer, merchant, or other type of user) operating any type of computing device such as a laptop, a desktop, a mobile device, or other appropriate computing device, and where the computing device is able to access the Internet (e.g., through an Internet connection). Additionally, in various embodiments, the computing device(s) described herein may execute a mobile application that provides for one or more aspects of the image-to-marketplace brokering system discussed below.

Oftentimes, purchasing decisions are made or influenced by images that a consumer sees while browsing social media, while performing a web-based search, while reading a news article, while reading e-mail, or while doing any of a variety of other tasks online. Moreover, actual purchases are typically made by way of an online marketplace platform, such as one of the online marketplace platforms mentioned above. Currently, when a consumer sees an image (e.g., posted on social media, in an image search, as part of a news feed, while reading email, as part of a banner advertisement, etc.) of something they would like to purchase, the consumer must first identify the item in the image and then go to the online marketplace platform and search for the item from the image. Then, assuming the consumer has correctly identified the item in the image, and assuming that their chosen online marketplace platform sells the item they are looking for, the consumer may ultimately be able to purchase the item from the image. Such a process can be quite inefficient, time-consuming, and frustrating.

By providing the image-to-marketplace brokering system as described herein, a user is able to quickly access information about an item and/or purchase the item without having to personally identify the item or perform their own web search for the item. As merely one example, in accordance with embodiments described herein, a user may express interest in an image (a picture) of an item which the user sees on social media. In some embodiments, the user may express interest by clicking on a “Like” button (e.g., such as used on Facebook.com, operated by Facebook, Inc. of Menlo Park, Calif.). Other methods of expressing interest in an image of an item will be discussed in more detail below. Generally, as used herein, the phrase “expressing an interest in an image” may equivalently mean to “like” an image. In various examples, upon expressing interest in the image of the item, the image-to-marketplace brokering system provided herein may search for merchandise listings (e.g., within various online marketplace platforms) related to the item shown in the image in which the user has expressed interest. The image-to-marketplace brokering system may thus collect any of a variety of information from merchandise listings, such as item specifications, price, availability, merchant information, similar products, or other relevant information and generate a marketplace summary of the item for presentation to the user. In some cases, the marketplace summary may include an infographic, a table, a chart, or other appropriate summary of the information. In some embodiments, the presented marketplace summary of the item may also include a mechanism to purchase the item, such as a “Buy” button. In various embodiments, the image-to-marketplace brokering system may additionally provide a checkout service. For example, after the user clicks the “Buy” button, the image-to-marketplace brokering system may simulate a guest checkout or facilitate a signed-in checkout process. In some cases, embodiments disclosed herein may further include a wallet translation service. For example, if a particular online marketplace platform does not support PayPal as a payment provider, then the image-to-marketplace brokering system may collect payment from the user and transfer payment to the particular online marketplace platform using an acceptable form of payment, all in a manner that is entirely invisible to the user purchasing the item. Various other embodiments and advantages of the present disclosure will become evident in the discussion that follows and with reference to the accompanying figures.

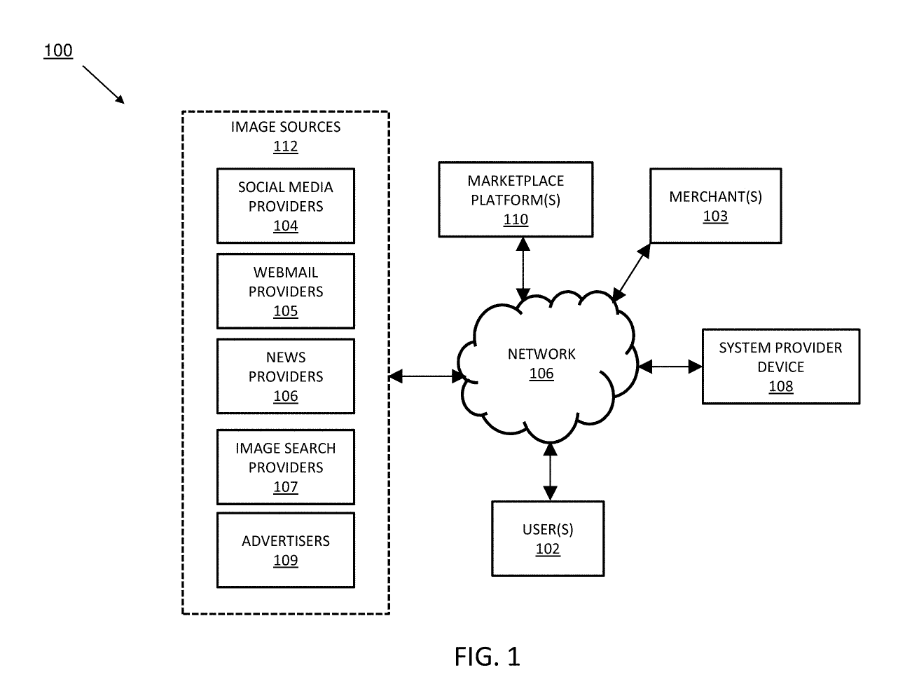

Referring now to FIG. 1, an embodiment of an image-to-marketplace brokering system 100 is illustrated. The image-to-marketplace brokering system 100 includes a user 102. In various embodiments, the user 102 may include any type of user (e.g., individual, customer, merchant, or other type of user) operating any type of computing device such as a laptop, a desktop, a mobile device, or other appropriate computing device. While the embodiments herein are generally shown and described with reference to a single user (e.g., user 102) for the sake of clarity, it will be understood that various embodiments may include a plurality of users at a plurality of user physical locations. In various examples, the user 102 includes, corresponds to, or is associated with one or more user devices (e.g., such as the computing devices described above) that are coupled to a network 106 that is further coupled to a system provider device 108. For example, the user 102 and the system provider device 108 are configured to communicate with one another by way of the network 106, for example by way of network communication devices, as discussed below.

In various examples, the embodiment of an image-to-marketplace brokering system 100 further includes a marketplace platform 110. As described above, the marketplace platform 110 may include an online market platform such as eBay, Amazon, Alibaba, as well as any of a variety of other online marketplace platforms. More generally, the marketplace platform 110 may include any of a plurality of electronic commerce (e-commerce) websites offering goods and/or services for sale from a merchant to a consumer (e.g., such as the user 102). To be sure, in some examples, the consumer may be another merchant, an individual customer, or other type of user. As such, the marketplace platform 110 may provide merchandise listings for the goods and/or services being sold. A “merchandise listing”, as used herein, may include an image of an item for sale, a description of the item for sale, a price of the item for sale, as well as other relevant item information. In various embodiments, the marketplace platform 110 includes one or more devices that are coupled to the network 106 that is further coupled to a system provider device 108. For example, the marketplace platform 110 and the system provider device 108 are configured to communicate with one another by way of the network 106, for example by way of network communication devices, as discussed below.

The image-to-marketplace brokering system 100 may also include a merchant 103. In various embodiments, the merchant 103 may include a merchant operating a physical merchant location and/or a merchant virtual storefront accessible to a customer via a website (e.g., accessible through an Internet connection using a mobile device and/or a personal computer) or via a mobile application executing on the customer's mobile device. While the embodiments herein are generally shown and described with reference to a single merchant (e.g., merchant 103) for the sake of clarity, it will be understood that various embodiments may include a plurality of merchants at a plurality of merchant physical locations, a single merchant having a plurality of merchant physical locations, a plurality of merchants operating a plurality of merchant virtual storefronts, and/or a single merchant operating a plurality of merchant virtual storefronts. In various examples, the merchant 103 includes one or more merchant devices that are coupled to the network 106 that is further coupled to a system provider device 108. For example, the merchant 103 and the system provider device 108 are configured to communicate with one another by way of the network 106, for example by way of network communication devices, as discussed below.

In the embodiments illustrated and discussed below, the merchant 103 may provide a physical location such as a department store, a restaurant, a grocery store, a pharmacy, a movie theater, a theme park, a sports stadium, and/or a variety of other merchant physical locations. Moreover, in some embodiments, the merchant 103 physical location may include a mobile merchant location such as a cart, kiosk, trailer, and/or other mobile merchant locations. In addition, in various embodiments, the merchant 103 may include a virtual storefront that serves to complement the merchant physical location. In still other embodiments, the merchant 103 may not include a merchant physical location, and may instead only include a merchant virtual storefront, as described above. Oftentimes, the merchant 103 may offer items for sale by way of merchandise listings provided via the marketplace platform 110. In some cases, the merchant 103 may alternatively, or additionally, offer items for sale by way of merchandise listings provided via a merchant's own virtual storefront (e.g., accessible through a merchant website).

As also illustrated in FIG. 1, the image-to-marketplace brokering system 100 includes a plurality of image sources 112. In various examples, the plurality of image sources 112 may include, but are not limited to, social media providers 104 (e.g., such as Facebook, Instagram, Twitter, etc.), webmail providers 105 (e.g., Gmail, Yahoo Mail, AOL Mail, etc.), news providers 106 (e.g., CNN, MSNBC, Fox News, Yahoo News, Google News, etc.), image search providers 107 (e.g., Google image search, Bing image search, Yahoo image search, etc.), as well as advertisers 109, or other web-based image sources. As discussed in more detail below, an image from one or more of the image sources 112 may correspond to and/or be substantially the same as an image used in a merchandise listing of an item offered for sale, for example, via the marketplace platform 110 or via a virtual storefront of the merchant 103. Thus, in accordance with various embodiments, when the user 102 expresses interest in an image provided by one of the image sources 112, the image-to-marketplace brokering system 100 may, among other operations, provide merchandise listing information (e.g., as extracted from the marketplace platform 110 or via a virtual storefront of the merchant 103) to the user 102, where the provided information corresponds to a merchandise listing which includes the same image (or substantially similar image) in which the user 102 expressed interest. In various examples, the image sources 112 may include one or more image source devices that are coupled to the network 106 that is further coupled to the system provider device 108. Thus, each of the image sources 112 may likewise couple to the network 106, and to the system provider device 108, via a wired or wireless connection.

The network 106 may be implemented as a single network or a combination of multiple networks. For example, in various embodiments, the network 106 may include the Internet and/or one or more intranets, landline networks, wireless networks, cellular networks, satellite networks, and/or other appropriate types of networks. In some examples, the user 102 may communicate through the network 106 via cellular communication, by way of one or more merchant network communication devices. In other examples, the user 102 may communicate through the network 106 via wireless communication (e.g., via a WiFi network), by way of one or more merchant network communication devices. In yet other examples, the user 102 may communicate through the network 106 via any of a plurality of other radio and/or telecommunications protocols, by way of one or more merchant network communication devices. In still other embodiments, the user 102 may communication through the network 106 using a Short Message Service (SMS)-based text message, by way of one or more merchant network communication devices.

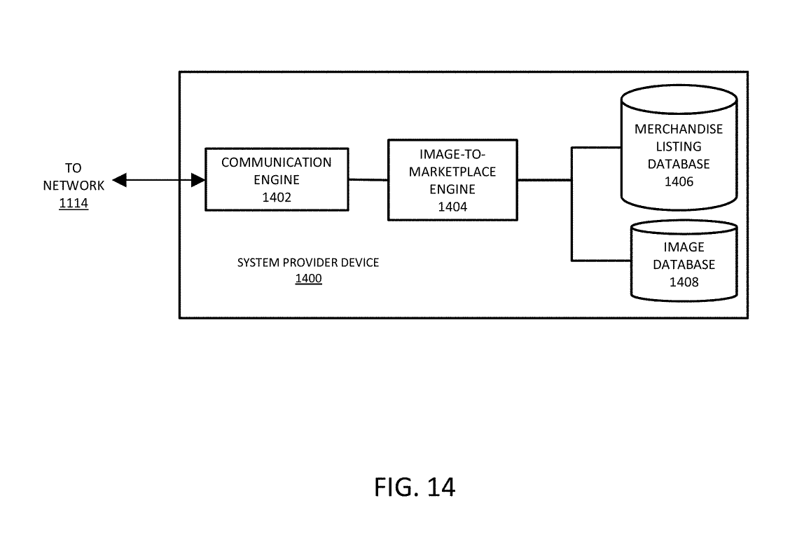

The system provider device 108 may likewise couple to the network 106 via a wired or wireless connection. As described in more detail below with reference to FIG. 14, the system provider device 108 may include an image-to-marketplace engine, a communication engine, an image database, and merchandise listing database. Software or instructions stored on a computer-readable medium, and executed by one or more processors of the system provider device 108, allows the system provider device 108 to send and receive information over the network 106. Furthermore, the image-to-marketplace engine in the system provider device 108 may be configured to implement the various embodiments of the image-to-marketplace brokering system 100 as described herein. In some examples, the system provider device 108 is configured to receive an indication of a user's 102 interest in the image of an item (e.g., such as an image provided to the user 102 via one of the image sources 112). In response, the system provider device 108 may search for merchandise listings (e.g., within the marketplace platform 110 or via a virtual storefront of the merchant 103) related to, or containing, the item shown in the image in which the user 102 has expressed interest. In various embodiments, the system provider device 108 may collect/extract any of a variety of information from the merchandise listings, such as item specifications, price, availability, merchant information, similar products, or other relevant information and generate a marketplace summary of the item shown in the image for presentation to the user 102 (e.g., by way of a user device). In some embodiments, the marketplace summary generated by the system provider device 108 may also include a mechanism to purchase the item, such as a “Buy” button. In various embodiments, the system provider device 108 may additionally provide a checkout service. By way of illustration, after the user 102 clicks the “Buy” button (e.g., on a display of the user device), the system provider device 108 may simulate a guest checkout or facilitate a signed-in checkout process. In some cases, the system provider device 108 may further include a wallet translation service, as described below. It is further noted that in some embodiments, the system provider (e.g., operating the system provider device 108) may include a payment service provider such as, for example, PayPal Inc. of San Jose, Calif., that provides the image-to-marketplace brokering system 100 for the user 102, as well as for any other users implementing the image-to-marketplace brokering system 100.

Information sent and received through the network 106, image source devices, marketplace platform devices, merchant devices, and user devices may be associated with images and/or merchandise listings in a database located in a non-transitory memory, and any use of that information may be stored in association with implementation of one or more aspects of embodiments of the image-to-marketplace brokering system 100. Furthermore, the payment service provider may provide the image-to-marketplace brokering system 100 for a plurality of different users, similarly as described for the user 102, discussed below. Thus, references to a system provider operating a system provider device below may refer to a payment service provider operating a payment service provider device, or may refer to any other entity providing an image-to-marketplace brokering system separate from or in cooperation with a payment service provider.

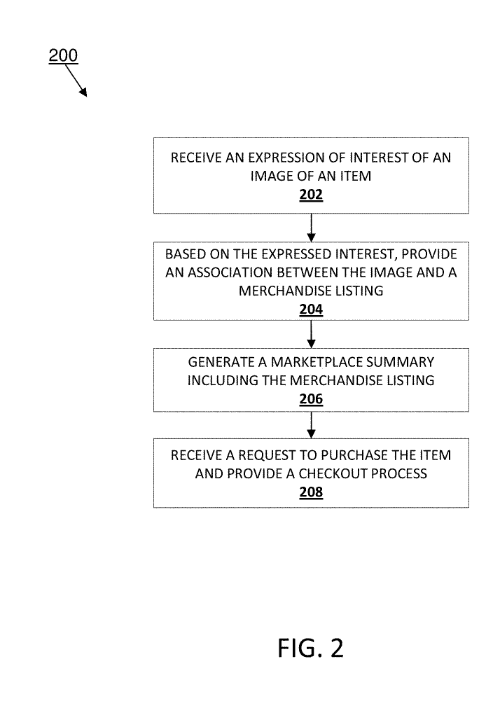

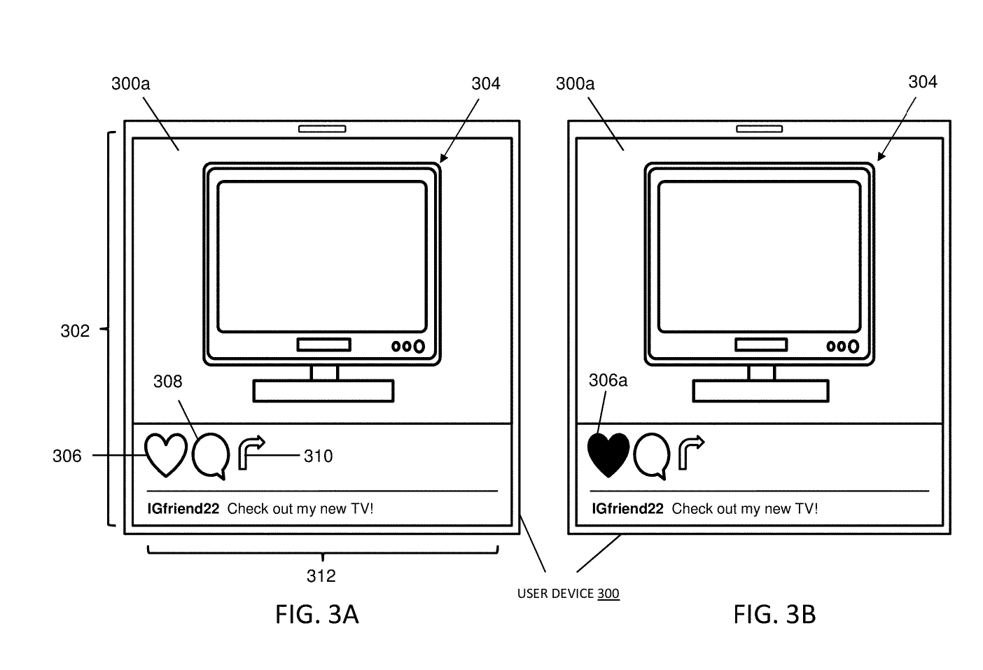

Referring now to FIG. 2, an embodiment of a method 200 for providing an image-to-marketplace brokering system is illustrated. One of skill in the art in possession of the present disclosure will recognize that the method 200 may be performed for any of a plurality of different users interacting with any of a plurality of image sources, for example, using any of a plurality of user devices, such as those previously described. It will also be understood that additional steps may be performed before, during, and/or after the steps described below with reference to the method 200. In particular, with reference to FIGS. 3A, 3B, and 4-10, various aspects of the method 200 are illustrated and described.

The method 200 begins at block 202 where an expression of interest of an image of an item is received. Referring first to FIGS. 3A and 3B, a user device 300 is illustrated that includes a display 300a and which may include a touchscreen user interface. The user device 300, in accordance with various embodiments of the present disclosure, may include a laptop computer, a desktop computer, a mobile phone, a tablet, and/or any of a variety of other type of computing device. In various embodiments, a user associated with the user device 300 may launch a system provider application and/or a payment service provider application (e.g., a payment application provided by PayPal, Inc. of San Jose, Calif.), for example, to express interest in an image of an item, to purchase an item, to view and/or update user settings, to view previously ‘liked’ images or previously generated marketplace summaries, or otherwise interact with the image-to-marketplace brokering system. In the various embodiments disclosed herein, the system provider application and/or a payment service provider application providing the image-to-marketplace brokering system may be implemented as one or more application program interfaces (APIs), as a plug-in (e.g., such as a web browser plug-in), or according to another appropriate method.

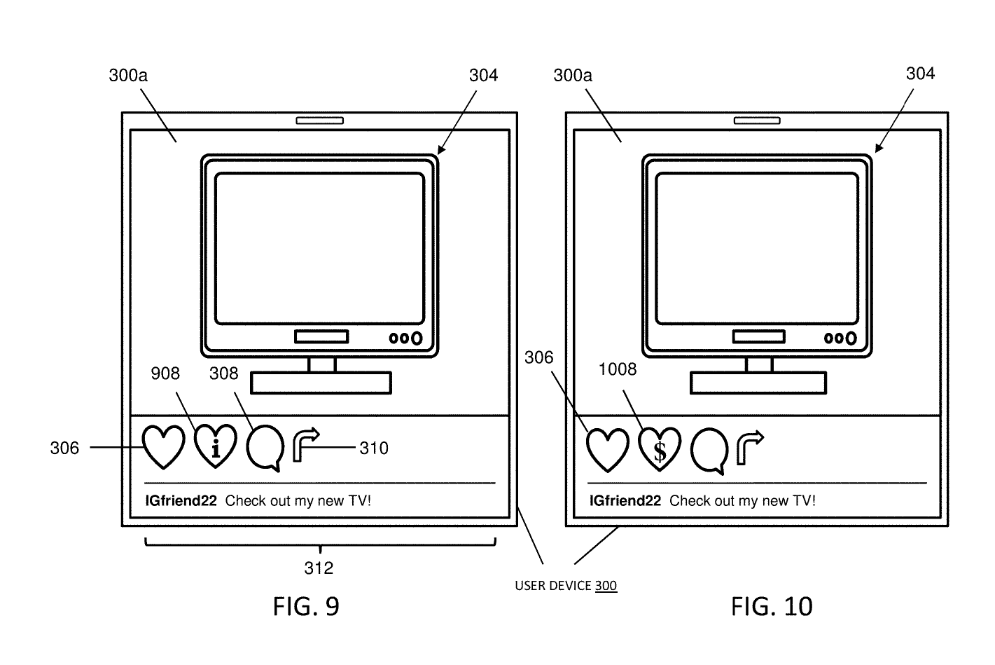

Consider, for example, a user browsing a social media feed (e.g., such as Facebook, Instagram, Twitter, etc.). Referring to FIG. 3A, and continuing with the present example, the user browsing the social media feed may see a post 302 from their friend with a username ‘IGfriend22’. As shown in the example of FIG. 3A, the post 302 includes a picture 304 of a television. In some embodiments, the post 302 may include a like icon 306, a comment icon 308, and a share icon 310. Additionally, in some cases, the post 302 may include a comment section 312. In the present example, a comment posted by ‘IGfriend22’ reads “Check out my new TV!” In some embodiments, and upon seeing the post 302 in their social media feed, the user (e.g., such as the user 102) may express interest in the picture 304 of the television by liking the post 302. In some examples, the user may like the post 302 by tapping (e.g., using a touchscreen interface of user device 300) on the like icon 306. As a result, and as shown in FIG. 3B, the like icon 306 becomes a filled like icon 306a. Additional examples of expressing interest in an image of an item are discussed below and/or discussed with reference to FIGS. 9 and 10. In some embodiments, after the user expresses interest in the picture 304 (e.g., by tapping the like icon 306), an indication of the expression of interest in the picture 304 may be provided to the system provider.

Thus, following block 202, the system provider device 108 has received an expression of interest of an image of an item (e.g., a television, in the example of FIGS. 3A and 3B). As discussed below, the system provider device 108 may then use the expression of interest to provide an association between the image and merchandise listing, and provide a marketplace summary (e.g., to the user 102), as described below.

The method 200 proceeds to block 204 where, based on the expressed interest in the image of the item, an association between the image and a merchandise listing is provided. By way of example, in an embodiment of block 204, the system provider may use the image in which the user has expressed interest (e.g., the picture 304) to search merchandise listings of various online marketplace platforms (e.g., such as eBay, Amazon, Alibaba), as well as merchant virtual storefronts, and/or any of a variety of other online marketplaces. Stated another way, the system provider may perform an image-based search of the merchandise listings, in an effort to find a merchandise listing that includes the exact picture used for the image-based search (e.g., the picture 304), and/or a merchandise listing that includes a picture of the exact or similar item to that shown in the image in which the user expressed interest (e.g., the television shown in the picture 304). In some examples, upon finding/identifying a suitable merchandise listing, the system provider generates an association between the identified merchandise listing and the image (e.g., the image used for the image-based search such as the picture 304). In some embodiments, as in the example of FIGS. 3A/3B where the ‘liked’ image is one posted on a social media feed, the generated association may be a loose association, at least initially, as it is unlikely (although not impossible) that a merchandise listing exists that includes the exact image that a user posts to a social media account. However, in various embodiments and as described in more detail below, such an initially loose association may become a hard association, for example, upon user validation and/or upon other feedback which can be used to strengthen the association. To be sure, in some cases, the initially created association may include a hard association (e.g., when using image metadata, as discussed below).

In some embodiments, and as part of the finding/identifying the suitable merchandise listing, the system provider may scrape the identified merchandise listing in order to extract any of a variety of information from the identified merchandise listing, such as item specifications, price, availability, merchant information, similar products, or other relevant information which may be used to generate a marketplace summary, discussed below. Thus, following block 204, the system provider device has generated an association between the identified merchandise listing and the image used for the image-based search, based at least in part on the user's expression of interest in the image.

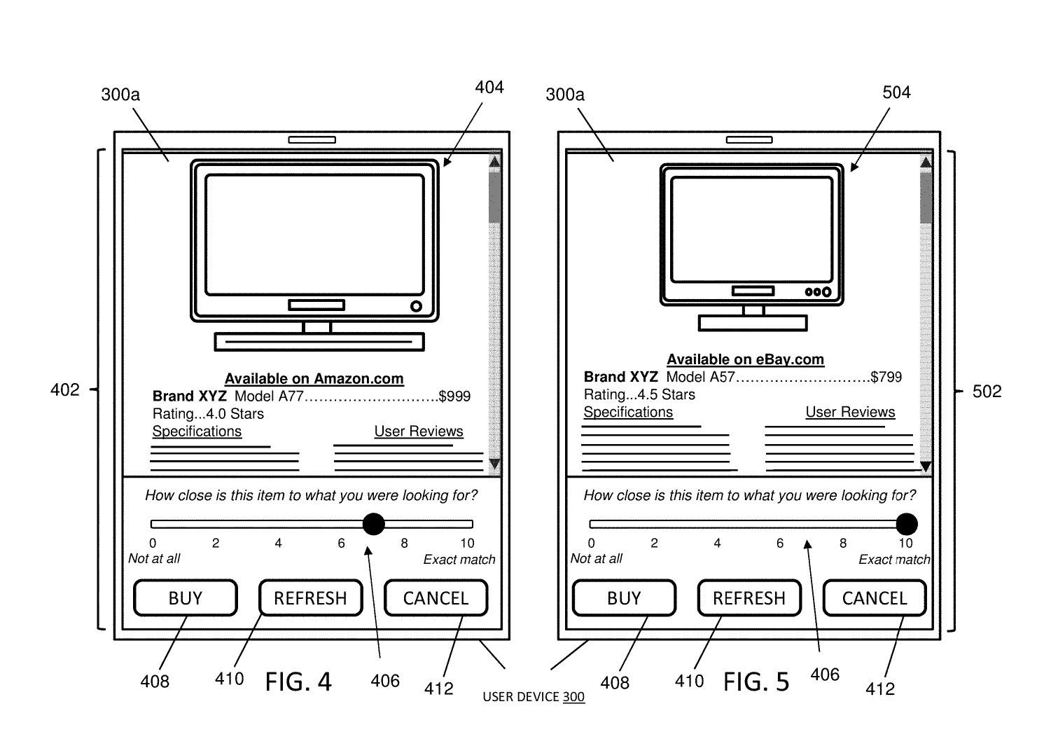

The method 200 proceeds to block 206 where, after providing the association between the image and a merchandise listing, and extracting information from the merchandise listing, a marketplace summary is generated. With reference to the example of FIG. 4, an embodiment of block 206 is illustrated. In particular, FIG. 4 shows the user device 300 where the display 300a includes a marketplace summary 402. In various embodiments, the marketplace summary may be presented as a pop-up window, as a new browser tab or browser window, as part of a separate application, or embedded within the application from which the user expressed interest in the image (e.g., embedded within a social media application), among other presentations. In some embodiments, the marketplace summary 402 includes information extracted from the merchandise listing to which the image has been associated (e.g., in block 204). For example, the marketplace summary 402 may include an image 404 of an item for sale in the identified merchandise listing, identification of which online marketplace is selling the item (e.g., Amazon.com in the present example), an item price and rating, as well as item specifications, user reviews, and/or any other relevant information that has been scraped/extracted from the identified merchandise listing.

In some cases, the marketplace summary 402 may also include a slider scale 406 that a user can adjust to indicate how close (how similar) the item shown in the image 404 is to the item shown in the image 304 (e.g., the picture in which the user expressed interest). Merely for purposes of illustration, and as shown in FIG. 4, a rating of ‘0’ may indicate that the item shown in the image 404 is ‘Not at all’ similar, and a rating of ‘10’ may indicate that the item shown in the image 404 is an ‘Exact match’. In the present example, the user has provided a rating of ‘7’, for example, as the item shown in the image 404 is close but not an exact match (e.g., correct brand but wrong model). Additionally, in some embodiments, the rating assigned by the user may be used to fine-tune the original ‘loose association’. For example, in some embodiments, if the user provides a rating greater than or equal to ‘5’, a prior ‘loose association’ may be elevated (e.g., to a ‘moderate association’). In some embodiments, elevation of the association indicates to the system provider that the image 404 and/or the identified merchandise listing may be used in the future when another user expresses interest in the same picture (e.g., the picture 304). In other embodiments, if the user provides a rating less than ‘5’, a prior ‘loose association’ may be downgraded (e.g., to ‘no association’). In some embodiments, such downgrading of the association indicates to the system provider that the image 404 and/or the identified merchandise listing should not be used in the future when another user expresses interest in the same picture (e.g., the picture 304). In some cases, a different type of scale and/or rating system may be used to indicate how close the item shown in the image 404 is to the picture in which the user expressed interest.

In various embodiments, the marketplace summary 402 may further include a buy button 408, a refresh button 410, and a cancel button 412. In some examples, if the user would like to purchase the item shown in the image 404 (e.g., from the indicated online marketplace), the user may click the buy button 408, thereby sending a purchase request to the system provider and resulting in the system provider providing a checkout process, as discussed below. Alternatively, if the user would like to search for a more accurate match (e.g., to the item shown in the image in which the user expressed interest), the user may click the refresh button 410 (e.g., to request an updated marketplace summary), and the system provider may again use the image in which the user has expressed interest (e.g., the picture 304) to search merchandise listings of various online marketplace platforms and merchant virtual storefronts. It is noted however, that a search performed as a result of clicking the refresh button 410 may result in a more accurate search result, due at least in part to the user-provided rating of the prior search result. Assuming the user clicks the refresh button 410, the system provider may find and/or identify another, more accurate merchandise listing, and the system provider may thus scrape the newly identified merchandise listing in order to extract any of a variety of information from the newly identified merchandise listing in order to generate a new marketplace summary. An embodiment of the newly generated marketplace summary is discussed below with reference to the example of FIG. 5. In some embodiments, if the user is not interested in purchasing the item shown in the image 404 or in searching for a more accurate match, the user may click the cancel button 412, and the system provider may close the marketplace summary 402 interface. In some examples, upon closing the marketplace summary 402 interface, the system provider may return the user to the previous application (e.g., the social media feed of FIG. 3B). More generally, in various cases, upon closing the marketplace summary 402 interface, the system provider may return a user to the application or web browser window from which the initial expression of interest in an image was indicated.

Referring to the example of FIG. 5, illustrated therein is a marketplace summary 502. In some embodiments, the marketplace summary 502 is generated when the user clicks the refresh button 410 (e.g., of the marketplace summary 402). As discussed above, the marketplace summary 502 may include a more accurate merchandise listing, as compared to the merchandise listing in the marketplace summary 402. The marketplace summary 502 may also include an image 504 of an item for sale in the identified merchandise listing, identification of which online marketplace is selling the item (e.g., eBay.com in the present example), an item price and rating, as well as item specifications, user reviews, and/or any other relevant information that has been scraped/extracted from the identified merchandise listing.

The marketplace summary 502 may also include the slider scale 406. As shown in the example of FIG. 5, the user has provided a rating of ‘10’, for example, to indicate that the item shown in the image 504 is an ‘Exact match’ to the item shown in the image 304 (e.g., the picture in which the user expressed interest). In some embodiments, the rating assigned by the user may again be used to fine-tune the any prior existing association. In the present example, and due to the user providing a rating of ‘10’, any prior association (e.g., ‘loose association’, ‘moderate association’, etc.) may be elevated (e.g., to a ‘hard association’). In various embodiments, elevation of the association indicates to the system provider that the image 504 and/or the identified merchandise listing may be used in the future when another user expresses interest in the same picture (e.g., the picture 304).

While the above examples of FIGS. 4 and 5 illustrate finding an exactly matching merchandise listing after a single click of the refresh button 410, it will be understood that such an example is merely exemplary and that in practice any number of iterations may be performed prior to finding an exact match, and in some cases an exactly matching merchandise listing may not be found. However, embodiments of the present disclosure also provide for finding merchandise listings of similar items, whether or not an exact match can actually be found. In addition, the examples shown above illustrate marketplace summaries which show only one merchandise listing at a time. However, various embodiments may alternately include any number of merchandise listings which a user may simultaneously review and interact with (e.g., view images for individual listings, read specifications and reviews, buy, refresh, cancel, etc.).

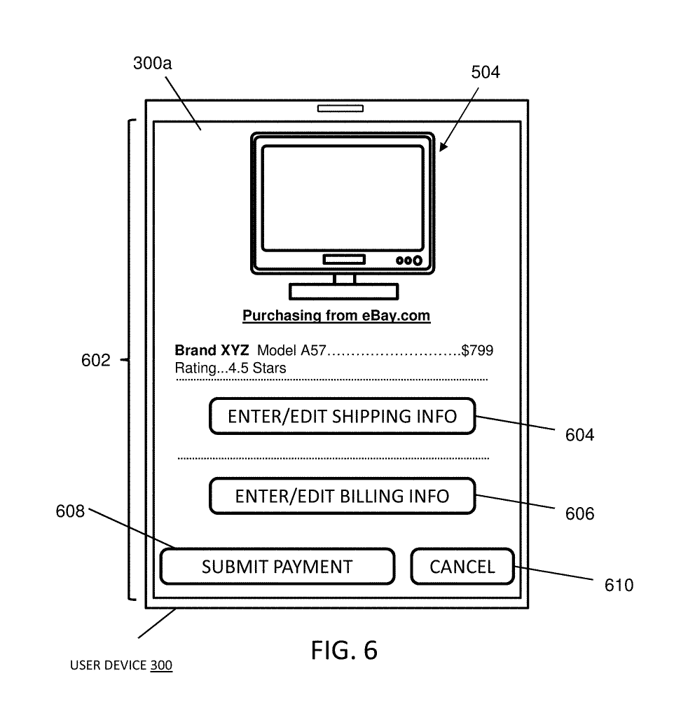

Thus, following block 206, the system provider device has generated a marketplace summary including one or more merchandise listings. Thereafter, the method 200 proceeds to block 208 where, a request to purchase an item is received and a checkout process is provided. With reference to the examples of FIGS. 5 and 6, an embodiment of block 208 is illustrated. Continuing with the above example, assume that the user has selected to buy the item shown in the image 504 of the marketplace summary 502 (e.g., from the online marketplace selling the item), by clicking the buy button 408. As a result, the system provider may provide a checkout interface 602 so that the user may complete the purchase transaction. In some embodiments, the checkout interface 602 includes the image 504 of the item to be purchased, identification of which online marketplace is selling the item (e.g., eBay.com), an item price and rating, a shipping information button 604, a billing information button 606, a submit payment button 608, and a cancel button 610. By way of example, the user may click the shipping information button 604 to enter and/or update shipping information (e.g., name and address) to which the item shown in the image 504 will be shipped. Likewise, the user may click the billing information button 606 to enter and/or update billing information (e.g., name, address, bank account information, payment service provider information, etc.) to which the purchase of the item should be charged and appropriate funds debited from the user's payment account. Generally, and in various examples, a user's “payment account” may include savings and/or checking accounts (and associated debit cards), lines of credit (and associated credit cards), and may further include a payment service provider account (e.g., a PayPal account), or other account, which is linked to one or more of such payment accounts. In various embodiments, and upon the user clicking the submit payment button 608, the system provider (e.g., which may include a payment service provider) may use a payment service provider device to transfer funds from the user payment account to a merchant account of the appropriate online marketplace (e.g., eBay.com, in the present example) to provide payment for the item listed in the merchandise listing. In addition, in some cases, the user may cancel the transaction by clicking the cancel button 610.

In some examples, completion of the purchase transaction as described above provides another manner in which any prior association (e.g., ‘loose association’, ‘moderate association’, etc.) may be elevated (e.g., to a ‘hard association’). For instance, consider an example where the user decided to purchase the item shown in the image 404 of the marketplace summary 402. Although this item was not an exact match (e.g., the user provided a rating of ‘7’, as discussed above), purchase of the item may indicate that the item shown in the image 404 may be of interest to users who express interest in the item shown in the image 304. Thus, elevation of the association (e.g., by way of the purchase transaction) also indicates to the system provider that the image and/or the identified merchandise listing may be used in the future when another user expresses interest in the same picture (e.g., the picture 304).

Moreover, in various embodiments, the system provider may provide a wallet translation service, if needed. As used herein, a “wallet” may refer to a digital wallet used to complete e-commerce transactions and which may be linked to one or more payment accounts. As an example of wallet translation, consider a situation where a particular merchant (e.g., including an online marketplace, an individual merchant selling items via an online marketplace, or a merchant selling items via their own virtual storefront) does not support Paypal (or other user-preferred method of payment) as a form of payment. Rather than require a user to interact directly with and/or create an account with that particular merchant in order to use the merchant's preferred form of payment, the payment service provider (e.g., Paypal) of the present disclosure may serve as a payment intermediary. For example, the payment service provider, already having access to the user's stored payment/billing information, may deduct funds from the user payment account (e.g., in an amount charged by the merchant providing the merchandise listing) and transfer the deducted funds into a payment service provider account. Additionally, the payment service provider may then transfer funds from the payment service provider account to a merchant account (e.g., a merchant account of the merchant providing the merchandise listing). More importantly, transfer of the funds from the payment service provider account to the merchant account may be performed using a form of payment that is acceptable to the particular merchant providing the listing. In some embodiments, the payment service provider may deduct a commission in order to complete such a wallet translation service. Thus, in other terms, “wallet translation” may include receiving a first form of payment from a user and transmitting a second form of payment to a merchant providing a merchandise listing. In addition, such wallet translation may be entirely invisible to the user making the purchase via the marketplace summary.

In various embodiments, the system provider may provide the checkout interface 602 using a guest checkout interface, where the user does not need to sign-in as a registered user to complete the checkout process. Alternatively, in some cases, the system provider may provide the checkout interface 602 using a signed-in checkout interface, where the user must sign-in as a registered user to complete the checkout process. In some examples, the signed-in checkout interface provides a more secure checkout experience for the user. In addition, by utilizing the signed-in checkout interface, the system provider may save user shipping information, billing information, purchase history, like history, and/or other user settings and preferences. In various embodiments, determination of whether to proceed using a guest checkout interface or a signed-in checkout interface may be left up to the user. However, in some cases, the system provider may default to a particular type of checkout interface (e.g., guest or signed-in), for example, based on requirements of a particular online marketplace.

While the above examples were discussed with reference to a user seeing an image posted on a social media feed (e.g., such as Facebook, Instagram, Twitter, etc.), embodiments of the present disclosure may be equally applicable to user interaction (e.g., expression of interest) with any of a plurality of images (e.g., from the plurality of image sources 112) such as webmail providers 105 (e.g., Gmail, Yahoo Mail, AOL Mail, etc.), news providers 106 (e.g., CNN, MSNBC, Fox News, Yahoo News, Google News, etc.), image search providers 107 (e.g., Google image search, Bing image search, Yahoo image search, etc.), as well as advertisers 109, or other web-based image sources. Thus, consider another situation where a user is performing an image search (e.g., using Google image search), for example, for the television discussed above (e.g., Brand XYZ Model A57). In this example, the image-to-marketplace brokering system may be running as a browser plug-in. By way of illustration, the search engine may return results including images from merchandise listings of various online marketplaces and/or merchant virtual storefronts. Moreover, as the returned search images include actual images used in merchandise listings, the images may additionally include metadata identifying the merchandise listing to which the image corresponds.

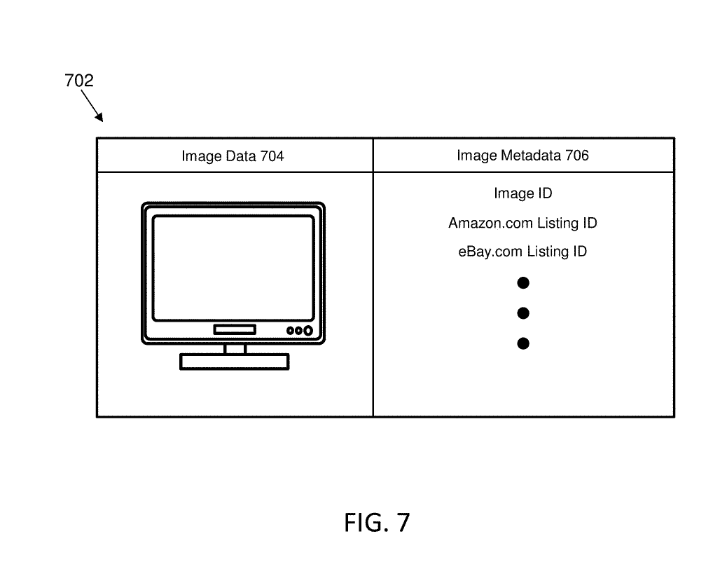

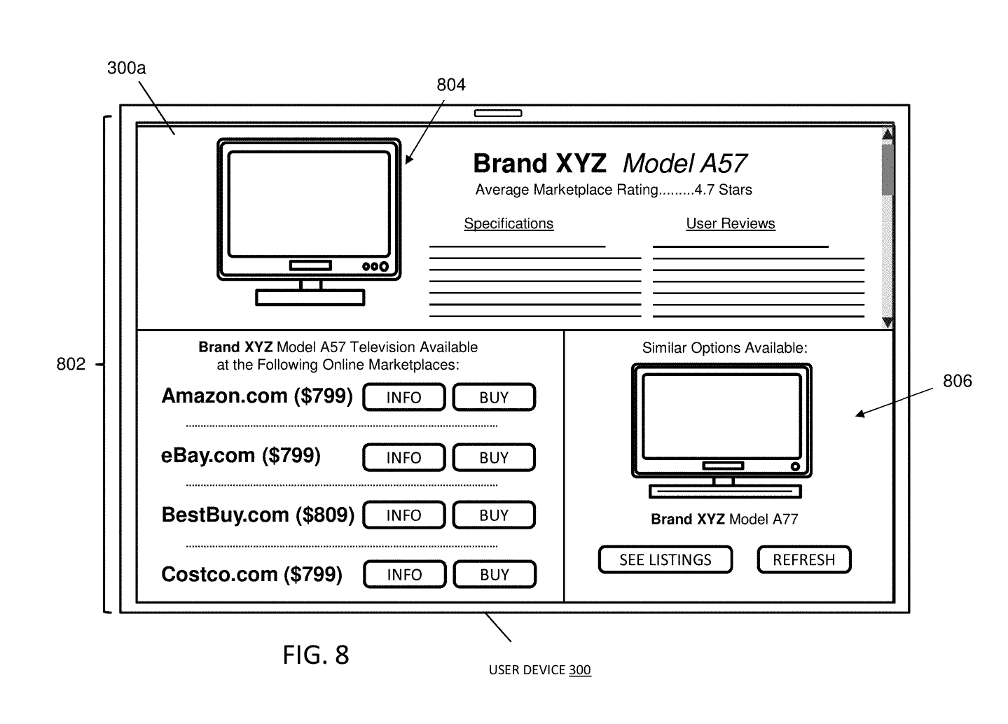

For example, with reference to FIG. 7, illustrated therein in an example of an image file 702, where the image file includes image data 704 and image metadata 706. In some embodiments, the image data 704 includes the actual image that the user sees as a result of their image search, and the image metadata 706 may include any of a variety of identifying information such as an image identification (Image ID), as well as a listing identification (Listing ID), and/or a merchandise listing website link, for each online marketplace that has a merchandise listing which includes the image represented by the image data 704. In some embodiments, the image metadata 706 may be provided by the online marketplace (e.g., Amazon.com, eBay.com, Alibaba.com, etc.), for example, when an image is uploaded to the online marketplace platform during the creation of a merchandise listing. In some embodiments, providing the image metadata 706 provides for an initial ‘hard association’ between an image and a merchandise listing. Thus, in some embodiments, upon receiving an expression of user interest in an image (block 202 of the method 200) retrieved via the image search (e.g., Google image search), the system provider may use the hard association provided by the image metadata 706 to provide a marketplace summary which includes the exact image in which the user expressed interest. Merely by way of illustration, a user may express interest in an image (e.g., retrieved via an image search or otherwise) by way of clicking on the image, by moving a cursor over the image, by downloading the image, or by other configurable interaction with the image. In some cases, if the same image is used across multiple online marketplaces and the image metadata 706 includes multiple listing ID's, the marketplace summary may provide any number of merchandise listings (e.g., corresponding to the number of listing ID's in the image metadata 706), which a user may simultaneously review and interact with (e.g., view images for individual listings, read specifications and reviews, buy, refresh, cancel, etc.). As an illustration of the above example, reference is made to FIG. 8, which shows a marketplace summary 802. As shown, the marketplace summary 802 may include an image 804 of the item for sale, a listing of the various online marketplaces selling the item (e.g., where the list was culled from image metadata 706) and the item price for each online marketplace, as well as item specifications, user reviews, and/or any other relevant information that has been scraped/extracted from each online marketplace using the image metadata 706. In some embodiments, the marketplace summary 802 may also include one or more suggestions 806 of similar items that may be of interest to the user.

To be sure, in some cases, image metadata may also be added to images posted to social media and which may not be the exact images used in a merchandise listing. In particular, once an initially ‘loose association’ is elevated to a ‘moderate association’ or a ‘hard association’, as described above, image metadata may be associated with such image files (e.g., indicating an identified merchandise listing) so that future expressions of interest in a particular image will result in a more efficient and accurate generation of the marketplace summary.

In some examples, as a result of the image search (e.g., such as the Google image search described above), the system provider may extract a website link and provide the website link to the user (e.g., via a marketplace summary page) who then clicks on the link. In some embodiments, clicking on the provided link may open the merchandise listing within the online marketplace itself (e.g. within eBay, Amazon, Alibaba, etc.). In some cases, such a provided link may be a soft link (e.g., referring to a link with a loose association). In some embodiments, the user may be able to optionally rate the accuracy of the provided website link, thereby allowing the system provider to update the association based on the provided user rating. In some cases, the user may provide such feedback by navigating back from the online marketplace web page to the marketplace summary page and specifying the accuracy of the link.

It will be understood that the examples given above, for example with reference to the method 200, are merely exemplary and are not meant be limiting in any way. Moreover, those of skill in the art in possession of this disclosure will recognize that various additional embodiments may be implemented in accordance with the methods described herein, while remaining within the scope of the present disclosure. For example, FIGS. 9 and 10 illustrate additional embodiments of the image-to-marketplace brokering system, in accordance with some embodiments. In some aspects, FIGS. 9 and 10 are substantially similar to the example of FIG. 3A, described above. However, in addition to providing the like icon 306, the comment icon 308, and the share icon 310, FIG. 9 also illustrates a ‘like+more information’ icon 908, which for example, may provide a brief snippet of additional information (e.g., by way of a pop-up window) with respect to the item shown in the image 304 without leaving the social media application, and/or in some cases without substantially obscuring a view of the social media feed. Alternatively, in some examples, the implementation shown in FIG. 9 may be used to separate simple/casual ‘likes’ (e.g., where the user is not interested in receiving more information about the item or purchasing the item) from ‘likes’ where the user does want more information and/or does want to purchase the item. For example, in some embodiments and with reference to the example of FIG. 9, the like icon 306 may alternatively be implemented to convey such simple/casual ‘likes’, and which do not result in generating a marketplace summary, which the ‘like+more information’ icon 908 is used to convey the expression of interest and generate the marketplace summary, in substantially the same manner as discussed above. In the example of FIG. 10, provided therein is a ‘like+buy’ icon 1008, which for example, may immediately provide a checkout interface (e.g., such as the checkout interface 602) for completion of the purchase transaction. In some cases, and with reference to the example of FIG. 10, the like icon 306 may also be implemented to convey simple/casual ‘likes’, or the like icon 306 may be implemented to convey the expression of interest and generate the marketplace summary, as discussed above, while the ‘like+buy’ icon 1008 may immediately provide the checkout interface.

In addition, in some embodiments, the image-to-marketplace brokering system may be configured as desired by the user, for example using a set of user-defined rules and/or settings. In some cases, the user may adjust settings and/or preferences of the image-to-marketplace brokering system such that the image-to-marketplace brokering system responds to expressions of interest for only those items, or category of items, for which the user is currently in the market. For instance, if the user is currently only interested in purchasing a television, the user may adjust settings of the image-to-marketplace brokering system such that marketplace summaries are generated only in response to the user expressing interest in pictures of televisions. In another example, the user may adjust settings of the image-to-marketplace brokering system such that marketplace summaries are generated in response to the user expressing interest in pictures of any type of electronics (e.g., televisions, speakers, computers, mobile phones, tablets, etc.). In some cases, the user may simply set the image-to-marketplace brokering system to ‘always on’ (e.g., generate marketplace summaries for all likes) or ‘always off’ (e.g., do not generate any marketplace summaries). In general, embodiments of the present disclosure provide for complete customization of the image-to-marketplace brokering system such that marketplace summaries may be generated for expressions of interest in any type of item, or category of items, in which the user chooses.

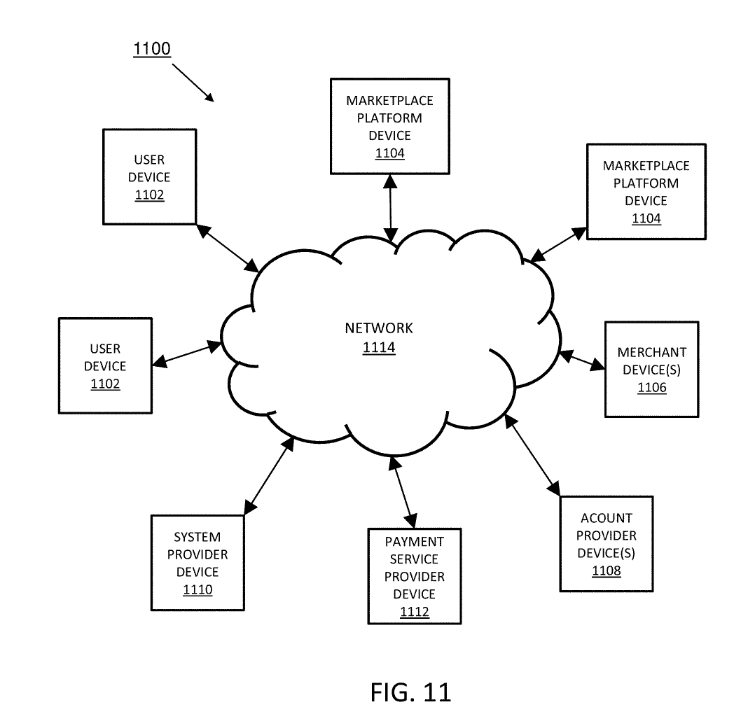

Thus, systems and methods have been described which provide an image-to-marketplace brokering system which brokers between an image and an online marketplace platform (e.g., such as eBay.com, Amazon.com, Alibaba.com, etc.). In various examples, and in accordance with the various embodiments described herein, the system provider device may receive an expression of interest of an image of a first item. In some embodiments, and responsive to the expression of interest, the system provider may then provide a first association between the image and a merchandise listing of a second item. The association may improve (e.g., become elevated), as described above, to become a hard association. In some cases the first and second items are the same, but in some cases they may be different. The system provider extracts information from the merchandise listing of the second item. Thereafter, and based on the extracted information, the system provider generates a marketplace summary including the information related to the merchandise listing of the second item. In various embodiments, the generated marketplace summary may be displayed by way of a user device. Thus, the embodiments described herein provide a user with the ability to quickly access information about an item and/or purchase the item that they like without having to personally identify the item or perform their own web search for the item. It is additionally noted that the embodiments described herein describe technological solutions to problems associated with e-commerce business practices, which include business practices that did not exist prior to the advent of computer networks and the Internet. Various examples of technological devices and systems that may be used to implement embodiments of the present disclosure are discussed in more detail below with reference to FIGS. 11-14.

Referring first to FIG. 11, an embodiment of a network-based system 1100 for implementing one or more processes described herein is illustrated. As shown, the network-based system 1100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 11 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1100 illustrated in FIG. 11 includes a plurality of user devices 1102, a plurality of marketplace platform devices 1104, a plurality of merchant devices 1106, a payment service provider device 1112, account provider device(s) 1108, and/or a system provider device 1110 in communication over one or more networks 1114. The user devices 1102 may be the user devices discussed above and may be operated by the users discussed above. The marketplace platform devices 1104 may be the marketplace platform devices discussed above and may be operated by the marketplace platforms discussed above. The merchant devices 1106 may be the merchant devices discussed above and may be operated by the merchants discussed above. The payment service provider device 1112 may be the payment service provider devices discussed above and may be operated by a payment service provider such as, for example, PayPal Inc. of San Jose, Calif. The system provider devices 1110 may be the system provider devices discussed above and may be operated by the system providers discussed above. The account provider devices 1108 may be operated by credit card account providers, bank account providers, savings account providers, and a variety of other account providers known in the art.

The user devices 1102, marketplace platform devices 1104, merchant devices 1106, payment service provider device 1112, account provider devices 1108, and/or system provider device 1110 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1114.

The network 1114 may be implemented as a single network or a combination of multiple networks. For example, in various embodiments, the network 1114 may include the Internet and/or one or more intranets, landline networks, wireless networks, and/or other appropriate types of networks.

The user devices 1102 and/or merchant devices 1106 may be implemented using any appropriate combination of hardware and/or software configured for wired and/or wireless communication over network 1114. For example, in one embodiment, the user devices 1102 and/or merchant devices 1106 may be implemented as a personal computer of a user in communication with the Internet. In other embodiments, the user devices 1102 and/or merchant devices 1106 may be a smart phone, wearable computing device, laptop computer, and/or other types of computing devices.

The user devices 1102 and/or merchant devices 1106 may include one or more browser applications which may be used, for example, to provide a convenient interface to permit the customer to browse information available over the network 1114. For example, in one embodiment, the browser application may be implemented as a web browser configured to view information available over the Internet.

The user devices 1102 and/or merchant devices 1106 may also include one or more toolbar applications which may be used, for example, to provide user-side processing for performing desired tasks in response to operations selected by the customer and/or the merchant. In one embodiment, the toolbar application may display a user interface in connection with the browser application.

The user devices 1102 and/or merchant devices 1106 may further include other applications as may be desired in particular embodiments to provide desired features to the user devices 1102 and/or merchant devices 1106. In particular, the other applications may include a payment application for payments assisted by a payment service provider through the payment service provider device 1112. The other applications may also include security applications for implementing user-side security features, programmatic user applications for interfacing with appropriate application programming interfaces (APIs) over the network 1114, or other types of applications. Email and/or text applications may also be included, which allow a user payer to send and receive emails and/or text messages through the network 1114. The user devices 1102 and/or merchant devices 1106 may include one or more user and/or device identifiers which may be implemented, for example, as operating system registry entries, cookies associated with the browser application, identifiers associated with hardware of the user devices 1102 and/or merchant devices 1106, or other appropriate identifiers, such as a phone number. In one embodiment, the user identifier may be used by the payment service provider device 1112 and/or account provider device 1108 to associate the user with a particular account as further described herein.

The merchant devices 1106 may be maintained, for example, by a conventional or online merchant, conventional or digital goods seller, individual seller, and/or application developer offering various products and/or services in exchange for payment to be received conventionally or over the network 1114. In this regard, the merchant device 1106 may include a database identifying available products and/or services (e.g., collectively referred to as items) which may be made available for viewing and purchase by the user.

The merchant devices 1106 and/or marketplace platform devices 1104 may also include a checkout application which may be configured to facilitate the purchase by the payer of items. The checkout application may be configured to accept payment information from the user through the user devices 1102, the account provider through the account provider device 1108, and/or from the payment service provider through the payment service provider device 1112 over the network 1114. The merchant devices 1106 and/or marketplace platform devices 1104 may also include a system provider application, as described above, to implement one or more aspects of the method 200 and/or other aspects of the various embodiments described herein.

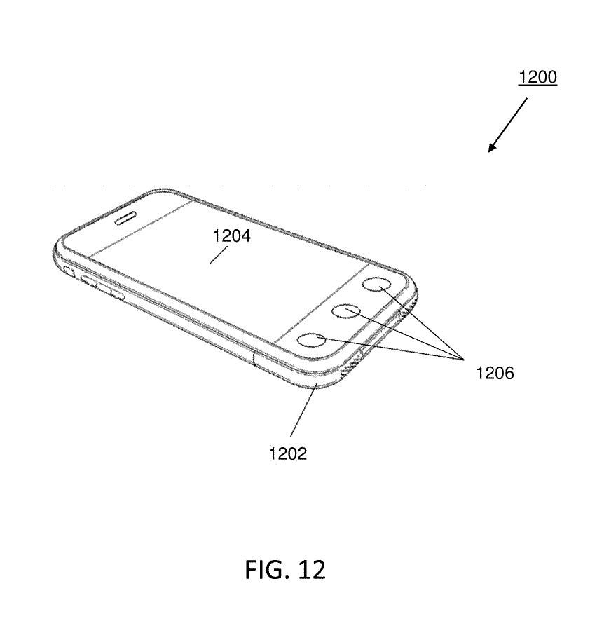

Referring now to FIG. 12, an embodiment of a user device 1200 is illustrated. The user device 1200 may be the user device 300 or 1102 discussed above. The user device 1200 includes a chassis 1202 having a display 1204 and an input device including the display 1204 and a plurality of input buttons 1206. One of skill in the art will recognize that the user device 1200 is a portable or mobile phone including a touch screen input device and a plurality of input buttons that allow the functionality discussed above with reference to the methods above. However, a variety of other portable/mobile merchant devices and/or desktop merchant devices may be used in the methods discussed above without departing from the scope of the present disclosure.

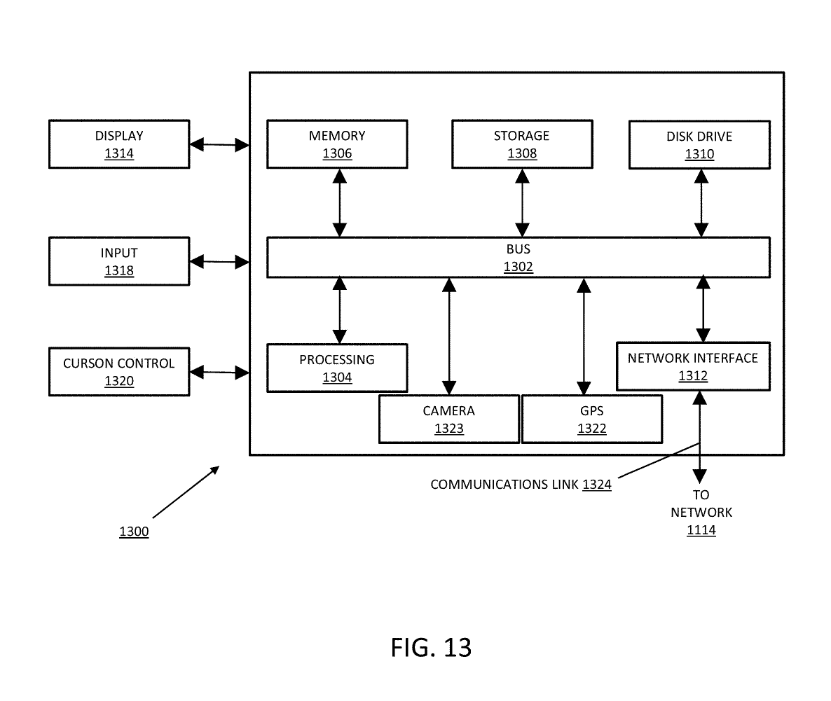

Referring now to FIG. 13, an embodiment of a computer system 1300 suitable for implementing, for example, the user device 300, 1102, or 1200, the marketplace platform device 1104, the merchant device 1106, the payment service provider device 1112, the account provider device(s) 1108, and/or the system provider devices 108 or 1110, is illustrated. It should be appreciated that other devices utilized by users, marketplace platforms, merchants, beacon devices, merchant beacon communication devices, payment service providers, account provider device(s), and/or system providers in the system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), a location determination component 1322 (e.g., a Global Positioning System (GPS) device as illustrated, a cell tower triangulation device, and/or a variety of other location determination devices known in the art), and/or a camera component 1323. In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the user device 300, 1102, or 1200, the marketplace platform device 1104, the merchant device 1106, the payment service provider device 1112, the account provider device(s) 1108, and/or the system provider devices 108 or 1110. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1114 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

Referring now to FIG. 14, an embodiment of a system provider device 1400 is illustrated. In an embodiment, the device 1400 may be the system provider devices discussed above. The device 1400 includes a communication engine 1402 that is coupled to the network 1114 and to image-to-marketplace engine 1404 that is coupled to a merchant listing database 1406 and an image database 1408. The communication engine 1402 may be software or instructions stored on a computer-readable medium that allows the device 1400 to send and receive information over the network 1114. The image-to-marketplace engine 1404 may be software or instructions stored on a computer-readable medium that, when executed by a processor, is configured to receive an expression of interest of an image, provide an association between the image and a merchandise listing, extract information from the merchandise listing, generate a marketplace summary, and display the marketplace summary by way of a user device, as well as provide any of the other functionality that is discussed above. While the databases 1406 and 1408 have been illustrated as located in the device 1400, one of skill in the art will recognize that they may be connected to the image-to-marketplace engine 1404 through the network 1114 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An image-to-marketplace brokering system, comprising:
a non-transitory memory; and
one or more hardware processors coupled to the non-transitory memory and configured to read instructions from the non-transitory memory to cause the system to perform operations comprising:
receiving an expression of interest of an image of a first item;
responsive to the expression of interest, providing a first association between the image and a merchandise listing of a second item;
extracting, from the merchandise listing of the second item, information related to the merchandise listing of the second item;
based on the extracted information, generating a marketplace summary including the information related to the merchandise listing of the second item; and
displaying, on a user device, the generated marketplace summary.

2. The system of claim 1, wherein the operations further comprise:
receiving a request to purchase the second item and providing, by way of the user device, a checkout interface; and
responsive to a payment request submitted via the checkout interface, receiving a funds transfer from a user payment account for completion of a purchase transaction of the second item.

3. The system of claim 1, wherein the operations further comprise:
responsive to the expression of interest, performing an image-based search of a plurality of merchandise listings and identifying the merchandise listing of the second item; and
based on the identifying the merchandise listing of the second item, providing the first association between the image and the merchandise listing of a second item.

4. The system of claim 2, wherein the operations further comprise:
receiving the funds transfer using a first form of payment; and
transmitting funds, using a second form of payment, to a merchant providing the merchandise listing of the second item.

5. The system of claim 2, wherein the first association is a loose association, and wherein upon completion of the purchase transaction, a second association between the image and the merchandise listing of the second item is provided, wherein the second association is a hard association.

6. The system of claim 1, wherein the operations further comprise:
receiving a rating of the first association that indicates a relative similarity between the first item and the second item; and
based on the received rating, providing an updated first association.

7. The system of claim 1, wherein the first item is the same as the second item.

8. The system of claim 1, wherein the operations further comprise:
receiving a request to refresh the marketplace summary;
responsive to the request to refresh the marketplace summary, providing a second association between the image and a merchandise listing of a third item;
extracting, from the merchandise listing of the third item, information related to the merchandise listing of the third item;
based on the extracted information, generating an updated marketplace summary including the information related to the merchandise listing of the third item; and
displaying, on the user device, the updated marketplace summary.

9. The system of claim 8, wherein the first item is different than the second item.

10. The system of claim 8, wherein the merchandise listing of the second item is provided by a first online marketplace, and wherein the merchandise listing of the third item is provided by a second online marketplace different than the first online marketplace.

11. The system of claim 1, wherein the operations further comprise:
prior to receiving the expression of interest of the image of the first item, providing image metadata for the image, wherein the image metadata identifies a particular merchandise listing of the second item, and wherein the first item is the same as the second item, wherein the generated marketplace summary further comprises information related to the particular merchandise listing of the second item.

12. A method for providing an image-to-marketplace brokering system, comprising:
receiving, by a system provider device through a network, an expression of interest of an image of a first item;
responsive to the expression of interest, providing, by the system provider device, a first association between the image and a merchandise listing of a second item;
extracting, by the system provider device and from the merchandise listing of the second item, information related to the merchandise listing of the second item;
based on the extracted information, generating, by the system provider device, a marketplace summary including the information related to the merchandise listing of the second item; and
displaying, by the system provider device and through a user device, the generated marketplace summary.

13. The method of claim 12, further comprising:
receiving, by the system provider device, a request to purchase the second item and providing, by the system provider device and through the user device, a checkout interface; and
responsive to a payment request submitted via the checkout interface, receiving, by the system provider device, a funds transfer from a user payment account for completion of a purchase transaction of the second item.

14. The method of claim 12, further comprising:
responsive to the expression of interest, performing, by the system provider device, an image-based search of a plurality of merchandise listings and identifying the merchandise listing of the second item; and
based on the identifying the merchandise listing of the second item, providing, by the system provider device, the first association between the image and the merchandise listing of a second item.

15. The method of claim 12, further comprising:
receiving, by the system provider device, a rating of the first association that indicates a relative similarity between the first item and the second item; and
based on the received rating, providing, by the system provider device, an updated first association.

16. The method of claim 12, further comprising:
prior to receiving the expression of interest of the image of the first item, providing, by the system provider device, image metadata for the image, wherein the image metadata identifies a particular merchandise listing of the second item, and wherein the first item is the same as the second item, wherein the generated marketplace summary further comprises information related to the particular merchandise listing of the second item.

17. A non-transitory machine-readable medium having stored thereon machine-readable instructions executable to cause a machine to perform operations comprising:
receiving an expression of interest of an image of a first item;
responsive to the expression of interest, providing a first association between the image and a merchandise listing of a second item;
extracting, from the merchandise listing of the second item, information related to the merchandise listing of the second item;
based on the extracted information, generating a marketplace summary including the information related to the merchandise listing of the second item; and
displaying, on a user device, the generated marketplace summary.

18. The non-transitory machine-readable medium of claim 17, wherein the operations further comprise:
responsive to the expression of interest, performing an image-based search of a plurality of merchandise listings and identifying the merchandise listing of the second item; and
based on the identifying the merchandise listing of the second item, providing the first association between the image and the merchandise listing of a second item.

19. The non-transitory machine-readable medium of claim 17, wherein the operations further comprise:
receiving a request to refresh the marketplace summary;
responsive to the request to refresh the marketplace summary, providing a second association between the image and a merchandise listing of a third item;
extracting, from the merchandise listing of the third item, information related to the merchandise listing of the third item;
based on the extracted information, generating an updated marketplace summary including the information related to the merchandise listing of the third item; and
displaying, by way of the user device, the updated marketplace summary.

20. The non-transitory machine-readable medium of claim 17, wherein the operations further comprise:
prior to receiving the expression of interest of the image of the first item, providing image metadata for the image, wherein the image metadata identifies a particular merchandise listing of the second item, and wherein the first item is the same as the second item, wherein the generated marketplace summary further comprises information related to the particular merchandise listing of the second item.
